(19) United States
(12) Patent Application Publication
(10) Pub. No.: US 2006/0071368 A1
(43) Pub. Date: Apr. 6, 2006

(54) Method and apparatus for compensating for in mold material shrinkage

(75) Inventor: Nikhil Mani, Billerica, MA (US)

Correspondence Address: KUDIRKA & JOBSE, LLP, ONE STATE STREET, SUITE 800, BOSTON, MA, 02109, US

(73) Assignee: Continental PET Technologies, Inc.

(21) Appl. No.: 10/958,617

(22) Filed: Oct. 4, 2004

(51) Int. Cl. B29C 43/02

(52) U.S. Cl. 264/319; 425/406

(57) ABSTRACT

A method of compression molding preforms for blow molding containers includes the steps of providing a preform mold that includes a mold cavity and a mold core, placing a mold charge of plastic resin into the mold cavity, advancing the mold core into the mold cavity to cause the mold charge resin to flow and fill a preform mold volume between the core and cavity, and then as the plastic resin cools and shrinks, advancing the mold core further into the mold cavity. Accordingly, in this method of compression molding plastic articles, the mold core is advanced into the mold cavity as the mold charge material cools and shrinks, to reduce the volume of the preform mold.

### FIELD OF THE INVENTION

The present invention relates generally to molding plastic articles, and more particularly to a method and apparatus for compression molding plastic articles.

### BACKGROUND OF THE INVENTION

Various plastic articles, such as plastic closures and preforms for containers, have been formed by a compression molding process. Some compression molding machines have a plurality of tools mounted in a circumferential array on a rotatable turret in a plurality of opposed coacting pairs. The tools of each pair carry opposed male and female mold sections that when closed together form a cavity mold for compression molding the desired articles.

During compression molding, a molten plastic mold charge pellet is disposed within a mold cavity of the mold tooling. Initial compression of the mold charge pellet distributes the material throughout the mold cavity to define the part shape. However, the volume of molten plastic is significantly greater than solidified plastic. Accordingly, as the plastic solidifies within the molten cavity it takes up less space or volume. If the mold cavity volume is maintained constant throughout the compression molding cycle, voids, sinks or other variations may appear in the final product due to the material shrinkage.

### SUMMARY OF THE INVENTION

A method of compression molding preforms for blow molding containers includes the steps of providing a preform mold that includes a mold cavity and a mold core, placing a mold charge of plastic resin into the mold cavity, advancing the mold core into the mold cavity to cause the mold charge resin to flow and fill a preform mold volume between the core and cavity, and then as the plastic resin cools and shrinks, advancing the mold core further into the mold cavity. Accordingly, in this method of compression molding plastic articles, the mold core is advanced into the mold cavity as the mold charge material cools and shrinks, to reduce the volume of the preform mold.

According to another aspect of the present invention, an apparatus for compression molding plastic articles includes at least one female mold section defining at least part of an open cavity, at least one male mold section including a mold core selectively receivable at least partially within the open cavity to define at least part of a preform mold cavity, and an alignment plate engageable with the female mold section to provide a seal between them and having an opening generally aligned with the opening of the cavity for receipt of the mold core through the opening. A mold core is received for reciprocation relative to the alignment plate and into the open cavity of the female mold section to change the volume of the preform mold cavity as the mold core moves relative to the female mold section.

### BRIEF DESCRIPTION OF THE DRAWINGS

These and other objects, features, advantages and aspects of the present invention will be apparent from the following detailed description of the preferred embodiments and best mode, appended claims and accompanying drawings in which:

FIG. 1 is an elevational view of a preform formed by one presently preferred embodiment of a method and apparatus of the present invention;

FIG. 2 is an elevational view of another embodiment of a preform that may be formed by a method and apparatus of the present invention;

FIG. 3 is an elevational view of a container that may be formed from the preform of FIG. 2;

FIG. 4 is a sectional view of an apparatus for compression molding preforms according to one embodiment of the present invention with mold tooling of the apparatus shown in an open position;

FIG. 5 is a cross-sectional view of the mold tooling shown in an intermediate position;

FIG. 6 is an enlarged fragmentary view of the encircled portion 6 of FIG. 5;

FIG. 7 is a sectional view of the mold tooling shown in its closed position; and

FIG. 8 is a enlarged fragmentary sectional view of the encircled portion 8 in FIG. 7.

### DETAILED DESCRIPTION OF THE PREFERRED EMBODIMENTS

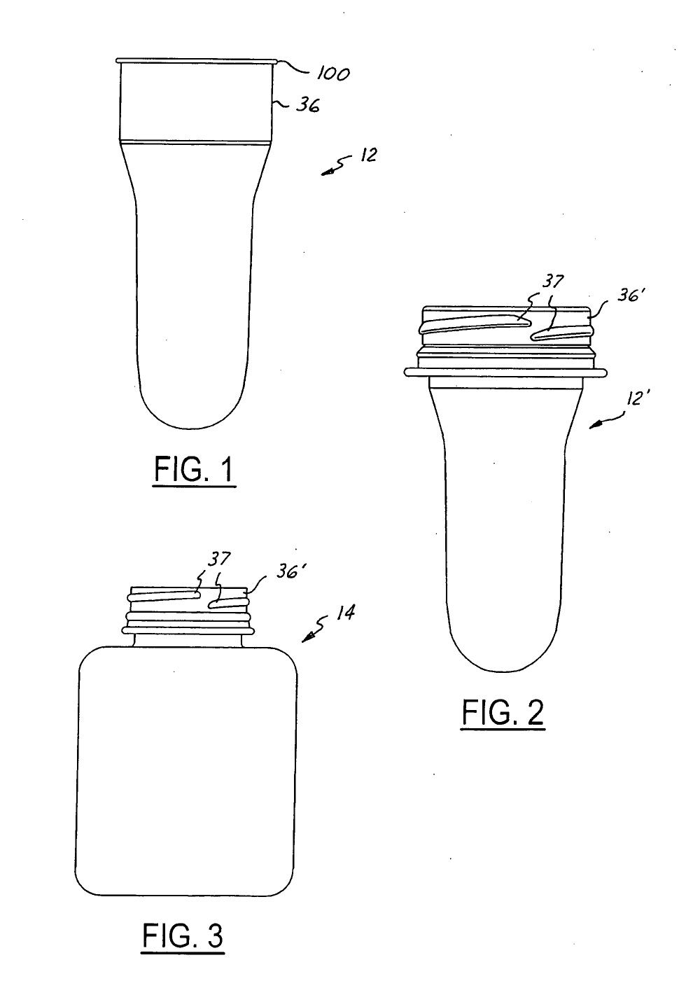

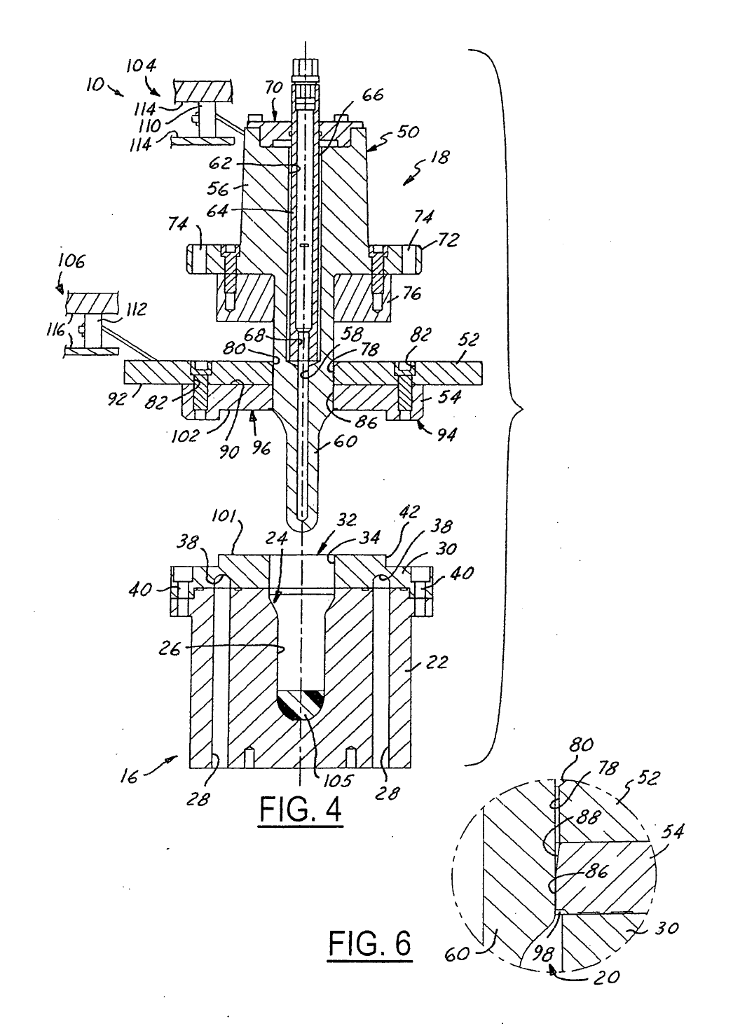

Referring in more detail to the drawings, FIGS. 4-8 illustrate a compression molding apparatus 10 for forming polymeric preforms 12, 12′ as shown in FIGS. 1 and 2, that can be subsequently formed into polymeric containers 14 of generally any size and shape, with one example shown in FIG. 3. The compression molding apparatus 10 includes a female mold section 16 and a male mold section 18 that are selectively mated to compression mold a mold charge pellet into a plastic preform 12. According to at least one aspect of present invention, the mold sections 16, 18 are initially moved to a first compression molding position defining a first volume of a preform mold cavity 20 in which the preform 12 is formed, and subsequently the male mold section 18 is advanced towards the female mold section 16 to a second compression molding position defining a second preform mold cavity volume less than the first mold cavity volume. Advancing the male mold section 18 relative to the female mold section 16 to reduce the mold cavity volume accommodates shrinkage of the plastic material of the mold charge pellet as it cools.

The female mold section 16 preferably includes a main body 22 having a cavity 24 with an inner surface 26 defining an outer surface of a plastic preform 12. One or more coolant passages 28 may be formed in the main body 22 through which a fluid is directed to cool the main body 22 in use. The main body 22 may be fixed to a housing, or may be yieldably biased in the housing, such as to protect the mold section 16 from a machine failure or other system fault. The female mold section 16 may be constructed substantially as shown in U.S. patent application Ser. No. 10/822,299, the disclosure of which is incorporated herein by reference in its entirety.

In one presently preferred embodiment, at least one neck ring mold element, such as split neck ring sections, or such as a unitary neck ring plate 30, is carried by and may be integral with or fixed to the main body 22. The neck ring plate 30 has a opening 32 or passage therein with an inner surface 34 designed to define part of the preform mold cavity 20, and form at least a portion of a neck 36 of a preform 12. In the embodiment shown in FIG. 4, a preform 12 is formed having the general shape shown in FIG. 1, wherein the neck 36 is generally smooth and cylindrical. Alternatively, the neck ring plate 30 and/or a portion of the female mold body 22 and/or split neck ring sections may have internal grooves defining external threads 37 on the neck portion 36′ of a preform 12′ as shown in FIG. 2. As another alternative, preform 12 may be made without external threads, and a separately formed finish ring may be secured to the preform prior to blow molding, or to the container neck after blow molding. Blind grooves 38 in the neck ring plate 30 preferably communicate with the coolant passages 28 in the main body 22 to receive coolant therein to cool the neck ring plate 30 in use. The neck ring plate 30 preferably has one or more circumferentially spaced and axially extending holes 40 adapted to receive a fastener to attach the neck ring plate 30 to the main body 22. An upstanding and generally cylindrical wall 42 surrounds the opening 32 and defines an alignment surface on the neck ring plate 30.

The male mold section 18 includes a mold core assembly 50, a carrier plate 52, and an alignment plate 54 carried by the carrier plate 52. The mold core assembly 50 includes a mold core body 56 with a central bore 58 and a mold core 60 at one end sized to be received in the cavity 24 of the female mold section 16 and the opening 32 of the neck ring plate 30 to define between them the preform mold cavity 20 in which a preform 12 is molded. A counterbore 62 is formed surrounding the blind bore 58 and an inner sleeve 64 is disposed within the counterbore 62. The outer diameter of the inner sleeve 64 is preferably smaller than the inner diameter of the counterbore 62 providing a gap 66 between them which may provide an air gap for insulation, or may receive a cooling fluid to facilitate cooling the mold core assembly 50. The inner sleeve 64 preferably has a through bore 68 aligned with the blind bore 58 and through which a coolant may be passed to facilitate cooling the mold core assembly 50 in use. The inner sleeve 64 may be retained on the mold core body 56 by a retainer 70 fixed to one end of the mold core body 56. The mold core assembly 50 may be constructed substantially as shown in U.S. patent application Ser. No. 10/822,299, the disclosure of which is incorporated herein by reference in its entirety. In addition, the mold core body 56 may have a radially outwardly extending flange 72 in which a plurality of holes 74 are provided to receive fasteners that connect an annular spacer plate 76 to the mold core body 56.

The carrier plate 52 is preferably annular with an opening 78 having an inner diameter that is preferably slightly larger than the outer diameter of the corresponding portion of the mold core body 56 so that a portion the mold core body 56 is slidably received for reciprocation through the opening 78. To facilitate assembly, the opening 78 may have a tapered entrance portion 80. A plurality of circumferentially spaced openings 82 are provided through the carrier plate 52 to receive fasteners that attach the alignment plate 54 to the carrier plate 52.

The alignment plate 54 is preferably generally annular, and carried by the carrier plate 52. A central opening 86 through the alignment plate 54 preferably has a minimum diameter sized to define a sealing surface that closely slidably receives the corresponding portion of the mold core body 56 permitting slidable reciprocation of the mold core body 56 relative to the alignment plate 54, while also providing a seal between them. As best shown in FIG. 6, the central opening 86 may have a radially outwardly tapered portion 88 limiting the surface area of contact between the mold core body 56 and the alignment plate 54 to facilitate the relative movement between these parts. One face 90 of the alignment plate 54 is preferably generally planar and received tightly against a generally planar adjacent surface 92 of the carrier plate 52. The opposite face 94 of the alignment plate 54 preferably includes a central recess 96 size to closely receive the alignment surface 42 of the neck ring plate 30, when the alignment plate 54 and neck ring plate 30 are brought together, to ensure proper orientation and location of the male mold section 18 relative to the female mold section 16. In one presently preferred embodiment, an annular groove 98 is formed in the alignment plate 54 extending radially outwardly from the central opening 86, and formed generally in the recess 96 of the alignment plate 54. Accordingly, the groove 98 defines part of the preform mold cavity 20 in which a plastic preform 12 is molded and, as best shown in FIG. 1, provides a radially outwardly extending lip 100 at one end of the preform 12. A portion of the groove 98, and hence a portion of the lip 100 of the preform 12, overlies a portion of the neck ring plate 30. Desirably, an upper face 101 of the alignment surface 42 of the neck ring plate 30, and an inner face 102 of the recess 96 of the alignment plate 54 are planar, and a seal is defined between them when they are pressed together during a compression molding cycle.

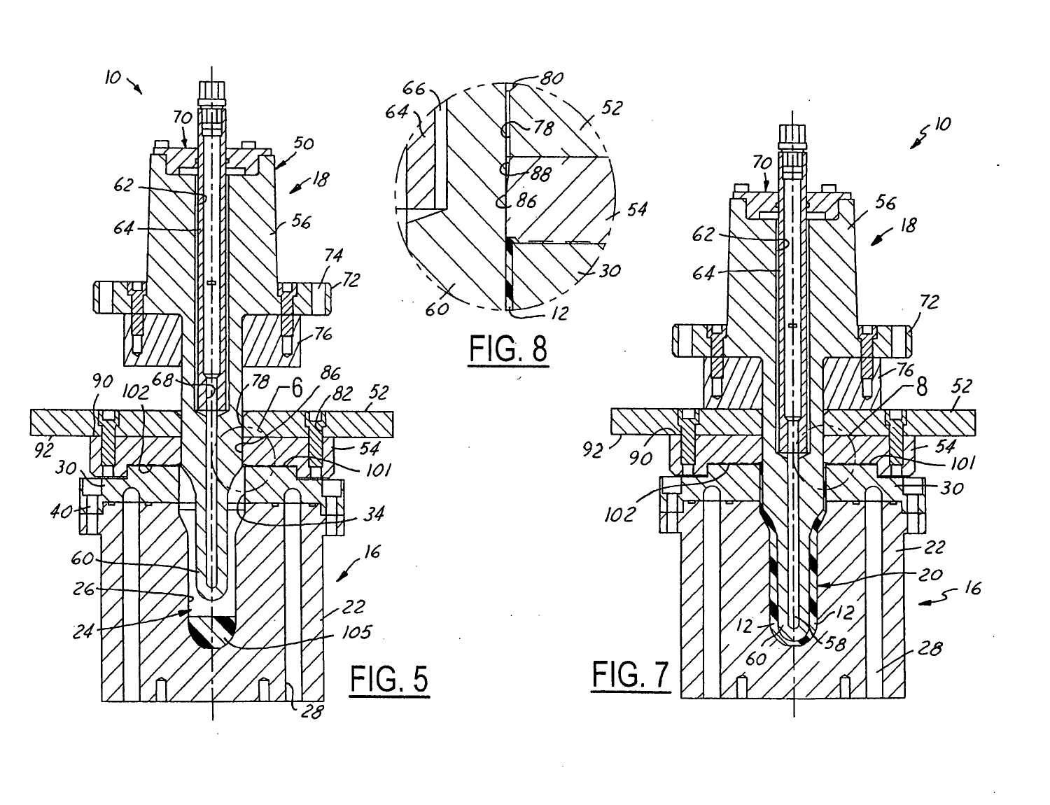

The mold core body 56 is preferably connected to a first actuator 104 (FIG. 4) that drives the mold core body 56 from a retracted position as shown in FIG. 4, spaced from the female mold section 16 to a fully advanced position, as shown in FIG. 7, with at least a portion of the male core 60 received in the cavity 24 of the female mold section 16. In its retracted position, the mold core 60 is removed from the female mold section 16 to permit a formed preform 12 to be removed from the mold tooling and a fresh mold charge pellet 105 (FIGS. 4 and 5) to be added to the female mold section 16. In the fully advanced position of the male mold section 18, the mold cavity 20 has its minimum volume defining the final shape and size of the molded plastic preform 12.

The carrier plate 52 is preferably associated with a second actuator 106 (FIG. 4) that drives the carrier plate 52 and alignment plate 54 between retracted and advanced positions. In the retracted position, as shown in FIG. 4, the alignment plate 54 is spaced from the neck ring plate 30, and in the advanced position, as shown in FIGS. 5-8, the alignment plate 54 is engaged with the neck ring 30 plate ensuring proper alignment and location of the male mold section 18 relative to the female mold section 16, and also providing a seal between the alignment plate 54 and neck ring plate 30.

In a compression molding cycle, the carrier plate 52 and alignment plate 54 may move at the same rate and at the same time as the mold core body 56 to a first position, as shown in FIG. 5, wherein the alignment plate 30 engages the neck ring plate 30 and the mold core 60 is disposed partially but not fully within the mold cavity 24. From this position, the mold core assembly 50 is advanced relative to the carrier and alignment plates 52, 54 disposing the mold core 60 further within the preform mold cavity 20 until it engages, compresses and causes the mold charge pellet to flow within and fill the mold cavity 20. In this position, the spacer plate 76 is spaced from the carrier plate 52. As previously noted, the plastic material shrinks as it cools, and thereby takes up a reduced volume within the mold cavity. To accommodate for the shrinkage, the mold core assembly 50 can be advanced further relative to the mold cavity 24 of the female mold section 16 to reduce the total volume of the preform mold cavity 20 and maintain desired pressure on the plastic material throughout the compression molding process. To limit movement of the mold core assembly 50 relative to the female mold body 22, the spacer plate 76 engages the carrier plate 52 preventing further relative movement between them, and defining the fully advanced position of the mold core assembly as shown in FIG. 7.

The actuator or actuators 104, 106 that move the mold core assembly 50 and the alignment and carrier plates 52, 54, may include cams 110,112, respectively, engageable with appropriately contoured cam surfaces 114, 116, respectively, to cause the axial displacement of these components relative to the female mold section. The alignment and carrier plates 52, 54, as well as the mold core assembly 50 may be yieldably biased toward their retracted positions, such that when the cam assembly is not active to advance these components, they may retract to open the mold cavity 20 and permit a formed part to be removed therefrom and a fresh mold charge pellet to be added. Of course, other arrangements and actuators can be used, and another cam surface may be used to move the components toward their retracted positions. In addition to or instead of the cam actuator 104, the mold core assembly 50 may be yieldably biased by a spring or may be acted on by a fluid cylinder, servo actuator, cam or other device that advances the mold core as the plastic material shrinks to maintain a generally constant force, or other desired force in the preform mold cavity 20. The mold core 60 can also be advanced by an actuator at a predetermined rate generally equal to the rate of material shrinkage.

While certain preferred embodiments, constructions, arrangements, and aspects of particular components of the compression molding apparatus have been shown and described herein, one of ordinary skill in this art will readily understand that modifications and substitutions can be made without departing from the spirt and scope of the invention as defined by the appended claims. Further, relative adjectives like “upper”, “lower”, “radial”, “axial” and the like are used to describe features of the apparatus and method with respect to the position and orientation of such features as shown in the accompanying drawings of the presently preferred embodiments, and are not intended to limit the scope of the invention.

1. A method of compression molding preforms for blow molding containers, which includes the steps of:
(a) providing a preform mold that includes a mold cavity and a mold core,
(b) placing a mold charge of plastic resin into said mold cavity,
(c) advancing said mold core into said mold cavity to cause said mold charge resin to flow and fill a preform mold volume between said core and said cavity, and then
(d) as said plastic resin cools and shrinks, advancing said mold core further into said cavity.

2. The method set forth in claim 1 wherein said preform mold provided in said step (a) includes at least one neck ring mold element adjacent to said cavity, wherein said step (c) includes advancing said mold core to cause the mold charge to fill the mold volume defined by said mold core, said mold cavity and said at least one neck ring mold element, and wherein said step (d) includes moving said mold core relative to said at least one neck ring mold element.

3. The method set forth in claim 2 wherein said step (d) includes holding said at least one neck ring mold element stationary with respect to said mold core.

4. The method set forth in claim 3 wherein said preform mold includes an alignment plate selectively engageable with said at least one neck ring mold element and step (c) includes engaging said alignment plate with said at least one neck ring mold element, and advancing said mold core relative to the alignment plate and said at least one neck ring mold element.

5. The method set forth in claim 4 wherein a seal is provided between the mold core and the alignment plate.

6. The method set forth in claim 5 wherein said seal is provided by part-to-part contact between the mold core and the alignment plate.

7. The method set forth in claim 4 wherein a seal is provided between the alignment plate and said at least one neck ring mold element.

8. The method set forth in claim 7 wherein said seal is provided by moving said alignment plate into engagement with said at least one neck ring mold element.

9. Apparatus for compression molding plastic articles, that includes:
at least one female mold section defining at least part of a mold cavity;
at least one male mold section including a mold core selectively receivable at least partially within said mold cavity to define at least a portion of a preform mold; and
an alignment plate engageable with said at least one female mold section to provide a seal between them and having an opening generally aligned with the mold cavity, with the mold core received through the opening for reciprocation relative to the alignment plate and into said mold cavity to change the volume of the preform mold as the mold core moves relative to said at least one female mold section.

10. The apparatus set forth in claim 9 wherein said at least one female mold section includes a female mold body and at least one neck ring mold element, and wherein during a compression molding cycle the alignment plate is engaged with the neck ring mold element to locate the male mold section relative to the female mold section, and the male mold core is movable relative to neck ring mold element and alignment plate further into the female mold body.

11. The apparatus set forth in claim 10 wherein the neck ring mold element and the alignment plate are held stationary as the male mold core is advanced further into the female mold body.

12. The apparatus set forth in claim 9 wherein the opening in the alignment plate includes a sealing surface against which the mold core is slidably received for reciprocation relative to the alignment plate to provide a seal between the alignment plate and the mold core.

13. The apparatus set forth in claim 12 wherein said sealing surface includes an entrance portion having a diameter larger than the diameter of the corresponding area of the mold core, and a sealing portion having a diameter sized to provide a seal between it and the mold core.

14. The apparatus set forth in claim 13 wherein the sealing surface is radially tapered between the entrance portion and sealing portion.

15. The apparatus set forth in claim 10 wherein said at least one neck ring mold element is carried by the female mold body.

16. The apparatus set forth in claim 10 wherein said at least one neck ring mold element and said alignment plate include mating alignment features that ensure they are aligned when they are mated together.

17. The apparatus set forth in claim 10 wherein at least one of said alignment plate and said neck ring mold element includes a groove that defines part of the mold cavity.

18. The apparatus set forth in claim 17 wherein said groove is formed in said alignment plate and provides a radially outwardly extending section of the mold cavity that overlies a portion of the neck ring mold element.
